(19) United States
(12) Patent Application Publication
(10) Pub. No.: US 2002/0128971 A1
(43) Pub. Date: Sep. 12, 2002

(54) Method for transmitting expense data to a server

(76) Inventor: Ezhilan Narasimhan, Cupertino, CA (US)

Correspondence Address: HOYT A. FLEMING III, P.O. BOX 140678, BOISE, ID, 83714, US

(21) Appl. No.: 09/843,208

(22) Filed: Apr. 25, 2001

Related U.S. Application Data
(60) Provisional application No. 60/275,285, filed on Mar. 12, 2001.

(51) Int. Cl. G06F 17/60

(52) U.S. Cl. 705/51; 705/1; 705/50

(57) ABSTRACT

A method of transmitting expense report data and expense item data to a server comprising: displaying a screen that includes a field for receiving expense report data; entering expense report data into the computer; displaying a screen that includes a field for receiving expense item data; entering expense item data into the computer; transmitting the expense report data to a server via a wireless network; and transmitting the expense item data to a server via the wireless network.

### RELATED APPLICATION

This application is a complete application based on the pending U.S. Provisional patent application Ser. No. 60/275,285 filed Mar. 12, 2001 and entitled MOBILE EXPENSE REPORTING: A DEMO APPLICATION FOR HAND-HELD DEVICES, which is hereby incorporated by reference. The filing date priority of the aforementioned provisional application is hereby claimed for the subject application.

### FIELD OF THE INVENTION

The present invention generally relates to expense reporting systems. More specifically, the present invention re lates to methods of transmitting expense data to a server.

### BACKGROUND

Many business travelers are aware of the difficulties of keeping accurate records of travel expenses. Accurately maintaining travel expense records is particularly difficult because the business traveler is away from her office. The business traveler may have access to sophisticated computer systems and/or well-trained staff to assist her when she is in her office. However, while the business traveler is away from her office, she may simply retain receipts and then attempt to associate the receipts with particular expense items after she returns to her office. As a result, when the business traveler generates an expense report after she returns to her office, the report may contain significant inaccuracies.

Thus, a need exists for a more accurate method of tracking travel expense information.

### SUMMARY OF INVENTION

One embodiment of the invention is a method of transmitting expense report data and expense item data to a server comprising: displaying a screen that includes a field for receiving expense report data; entering expense report data into the computer; displaying a screen that includes a field for receiving expense item data; entering expense item data into the computer; transmitting the expense report data to a server via a wireless network; and transmitting the expense item data to a server via the wireless network.

Another embodiment of the invention also includes: receiving a final expense report ID from the server; and replacing a temporary expense report ID in the computer with the final expense report ID.

Another embodiment of the invention is a method of transmitting expense report data and expense item data to a server comprising: entering a user ID into a computer; entering a password into the computer; displaying a screen that includes a field for receiving expense report data; entering expense report data into the computer; displaying a first screen that includes a field for receiving expense item data; entering first expense item data into the computer; displaying a second screen that includes a field for receiving expense; entering second expense item data into the computer; transmitting the expense report data to a server via a wireless network; transmitting the first expense item data to a server via the wireless network; and transmitting the first expense item data to a server via the wireless network.

Still another embodiment of the invention is a program storage device containing instructions that when executed by a computer perform the following acts: displaying a first screen, the first screen containing a field for receiving a user ID and a field for receiving a password; displaying a second screen, the second screen containing a field for receiving expense report data; displaying a third screen, the third screen containing a field for receiving expense item data; and displaying a third screen that indicates the status of a wireless data transfer from the computer to a server.

### BRIEF DESCRIPTION OF THE FIGURES

FIG. 1 presents a Login screen.

FIG. 2 presents a Report screen.

FIG. 3 presents a New Expense Report screen.

FIG. 4 presents an Expense screen.

FIG. 5 presents a New Expense Item screen.

FIG. 6 presents another embodiment of a New Expense Item screen

FIG. 7 presents an Expense Type screen.

FIG. 8 presents a Receipt Type screen.

FIG. 9 presents another embodiment of an Expense screen.

FIG. 10 presents another embodiment of a Report screen.

FIG. 11 presents a Status screen.

FIG. 12 presents a flow chart of one embodiment of the invention.

FIG. 13 presents a flow chart of another embodiment of the invention.

FIG. 14 presents a flow chart of still another embodiment of the invention.

### DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

One embodiment of the invention is a computer program running on a hand-held computer. Hand-held computers are also known as personal-digital-assistants (PDA). As discussed in detail below, the computer program generates expense reports and expense items. In addition, the computer program allows a user to enter expense report and expense item data. After the computer program stores such data, the computer program transmits the data to a server, such as a server at the user's home office. Such a computer program provides numerous benefits to a user as more fully discussed in Section 5.8.

5.1 Logging into the Expense Reporting Program

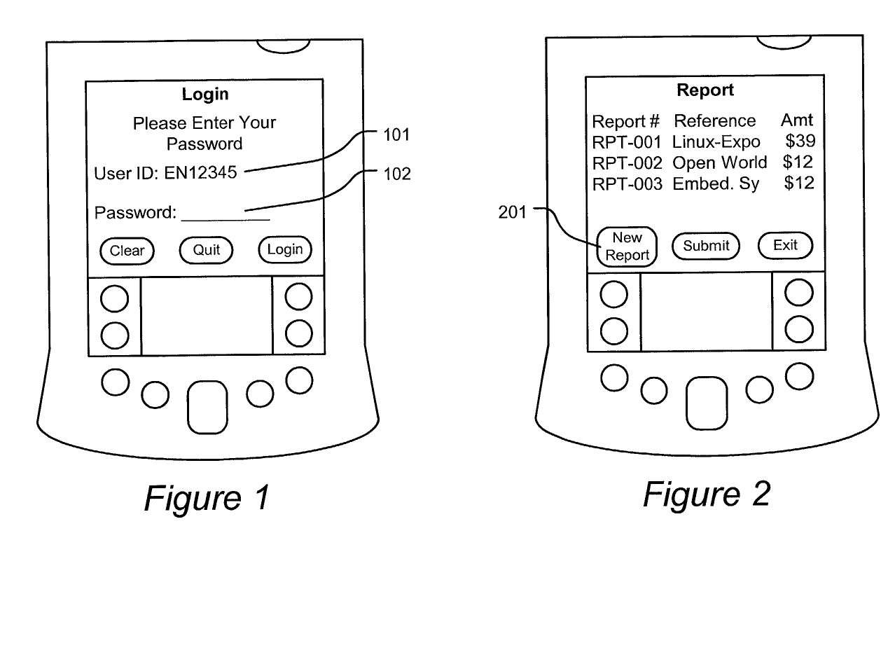

In one embodiment of the invention, a user would execute a computer program on a computer, such as a hand-held computer. In this embodiment, the computer program would then display a “Login” screen. An example of a Login screen is shown in FIG. 1. The Login screen may contain a field 101 for receiving a user ID and a field 102 for receiving a password. After the Login screen is displayed, the user may enter her user ID and her password into the computer. In some embodiments of the invention, the user ID and password may be entered via a keyboard or a stylus. Alternatively, such information can be entered into the computer through voice recognition software or other methods known in the art.

After the user has entered her user ID and password into the computer, the computer program can verify that the user ID and password are valid. If the user ID and password are invalid, then the computer program can display an error message.

5.2 Generating an Expense Report

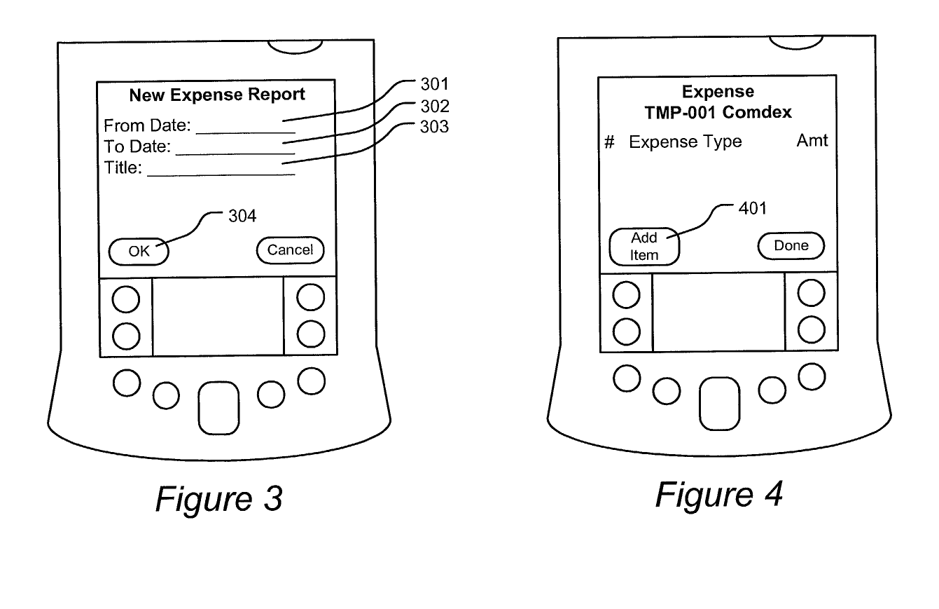

If the user ID and password are valid, then the computer program can display a “Report” screen that displays a list of previously generated expense reports, if any. An example of a Report screen is shown in FIG. 2. The Report screen shown in FIG. 2 presents the final expense report ID, the expense report title, and the sum of the expense items for three previously generated reports. In one embodiment of the invention, the user can instruct the computer to generate a new expense report by selecting the “New Expense Report” icon 201. The computer program then generates a temporary expense report ID and displays a “New Expense Report” screen. An example of such a New Expense Report screen is shown in FIG. 3.

The New Expense Report screen typically contains fields for receiving expense report data. For example, the New Expense Report screen may contain a field 301 for receiving the beginning date and a field 302 for receiving the last date of a business trip. In addition, the New Expense Report screen may contain a field 303 for receiving the title of the expense report. The New Expense Report screen may also include other fields (not shown) such as fields for receiving the identity of traveling companions and a description of the purpose of the business trip.

5.3 Entering Expense Report Data into the Computer

After the New Expense Report screen is displayed, the user may enter expense report data, such as described in Section 5.2, into the computer. The data may be entered via a keyboard or a stylus. Alternatively, such information can be entered into the computer through voice recognition software or any other methods that are known by those of skill in the art. After the expense report data is entered into the computer, the user can select the “OK” icon 304 and the computer program will store the expense report data and the temporary expense report ID. In some embodiments of the invention, the expense report data and the temporary expense report ID are stored in a single file. In some embodiments of the invention, after the expense report data and the temporary expense report ID are stored, the computer program will display an “Expense” screen. An example of an Expense screen is shown in FIG. 4.

5.4 Generating an Expense Item

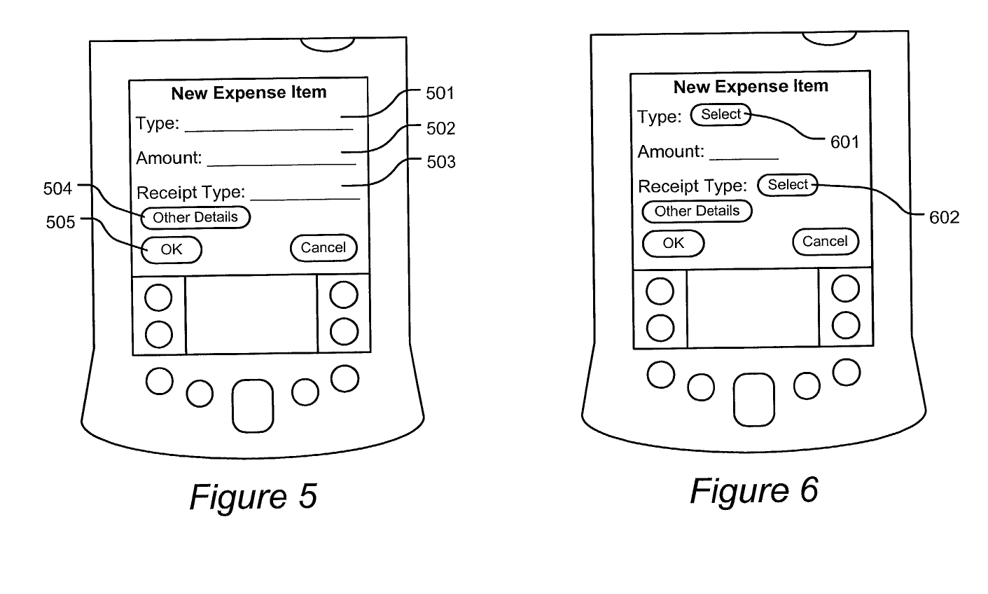

In one embodiment of the invention, the user can instruct the computer to generate a new expense item by selecting the “Add Item” icon 401 shown in FIG. 4. The computer then generates an expense item ID and displays a “New Expense Item” screen. An example of a New Expense Item screen is shown in FIG. 5.

5.5 Entering Expense Item Data into the Computer

The New Expense Item screen may contain fields for receiving expense item data. For example, the New Expense Item Screen may contain a field 501 for receiving the type of the expense item, a field 502 for receiving the amount of the expense item, and/or a field 503 for receiving the type of receipt for the expense item. The New Expense Item screen may include other fields as well. In some embodiments of the invention, the user would manually enter data into the fields as discussed above via stylus or keyboard.

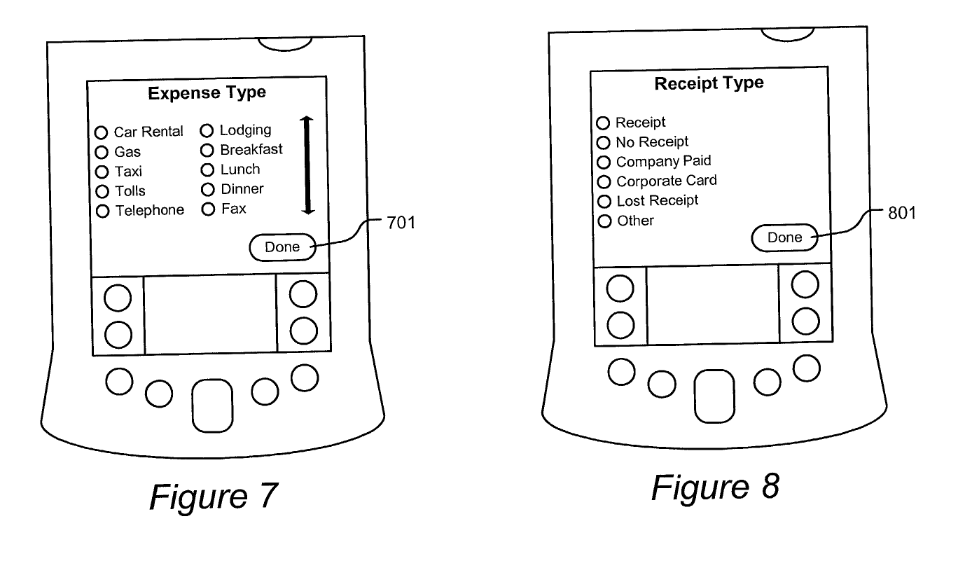

In other embodiments of the invention, such as shown in FIG. 6, the user need not manually enter the type of the expense item. Instead, the user can select from a plurality of expense types. In such embodiments, the user can select the “Select” icon 601 and the computer program will display an “Expense Type” screen. An example of an Expense Type screen is shown in FIG. 7. After the computer program has displayed an Expense Type screen, the user can select an expense type by selecting the radio button next to the desired expense type. When the user returns to the New Expense Item screen by selecting the “Done” icon 701, the computer program displays the selected expense type instead of the “Select” icon 601.

In other embodiments of the invention, the user need not manually enter the type of the receipt for the expense item. Instead, the user can select from a plurality of receipt types. In such embodiments, the user can select the “Select” icon 602 and the computer program will display a “Receipt Type” screen. An example of a Receipt Type screen is shown in FIG. 8. After the computer program has displayed a Receipt Type screen, the user can select a receipt type by selecting the radio button next to the desired receipt type. When the user returns to the New Expense Item screen by selecting the “Done” icon 801, the computer program displays the selected receipt type instead of the “Select” icon 602.

In still other embodiments of the invention the user may also enter other expense item details. For example, the user can select the “Other Details” icon 504 and the computer program will display a “Details” screen (not shown) that allows the user to enter notes and other information related to the expense item. In some embodiments, the Details screen would include fields for receiving data that vary based upon the expense type, and/or receipt type previously entered by the user. For example, if the user entered “Taxi” as an expense type, then the Details screen may include fields for receiving the original location and the destination location. On the other hand, if the user entered “Fax” as an expense type, then the Details screen may include fields for receiving the recipient of the facsimile.

After the user has entered the expense item data, the user can select the “OK” icon 505 and the computer program will store the entered expense item data. In some embodiments of the invention, the computer program will store the expense item data and an expense item ID in the same file as the temporary expense report ID and the expense report data. In other embodiments of the invention, the computer program will store the expense item data, the expense item ID and the temporary expense report ID in a separate file. By storing the temporary expense report ID in the file with the expense item data, the computer program can associate expense items with expense reports stored in other files. In some embodiments of the invention, after the computer program has stored the expense item ID and the expense item data, the computer program will display an Expense screen (not shown) that includes the ID, the type, and the amount of the expense item.

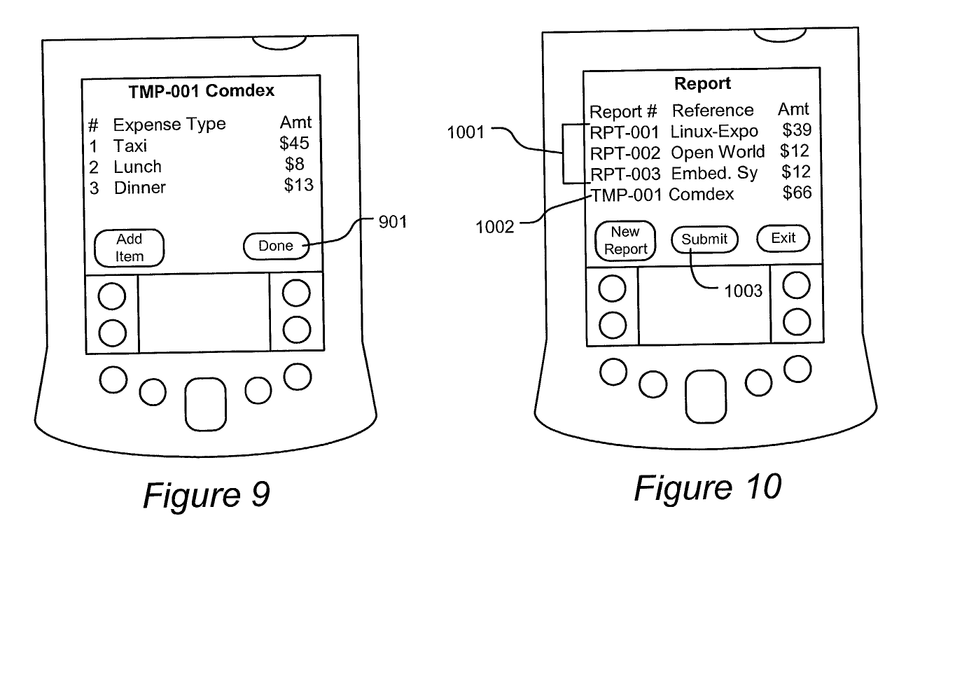

The above steps can be repeated to add additional expense items. FIG. 9 presents an Expense screen after a user has entered three expense items. If the user selects the “Done” icon 901, the computer program will display a Report screen, such as shown in FIG. 10. The Report screen shown in FIG. 10 is similar to the report screen shown in FIG. 2 except that the Report screen shown in FIG. 9 contains an additional entry for a newly entered expense report.

The Report screen shown in FIG. 10 displays a final expense report ID 1001, RPT-xxx, next to three expense report titles. In addition, the Report screen displays a temporary expense report ID 1002, TMP-001, next to one expense report title. In some embodiments of the invention a final expense report ID is only assigned to an expense report after the expense report has been transmitted to a server as discussed in Section 5.6. Thus, in such embodiments a user can determine if an expense report has been transmitted to a server by reviewing a Report screen such as shown in FIG. 10.

In other embodiments of the invention, the computer program would not display either the temporary or the final expense report IDs to the user. Instead, the computer program would identify expense reports that had been previously transmitted to a server via other methods, such as displaying “Submitted,” “S.” “Transmitted,” “T”, “√,” ,“ [symbol] ” or another symbol next to the expense report title if the expense report has been previously transmitted to a server.

5.6 Transmitting the Expense Report to a Server

If the user selects the “Submit” icon 1003, then in some embodiments of the invention, the computer program sends the expense report data and the expense item data to a server via a wireless network. For example, the computer could send the data via the Palm wireless network. Alternatively, the computer could send the data via a cellular phone network. In some embodiments of the invention the computer program also sends the temporary expense report IDs to the server. The server then sends final expense report IDs to the computer. In such embodiments, the temporary expense report IDs stored within the computer are replaced with the final expense report IDs received from the server. If no final expense report IDs are received from the server, then the computer may display an error message to the user.

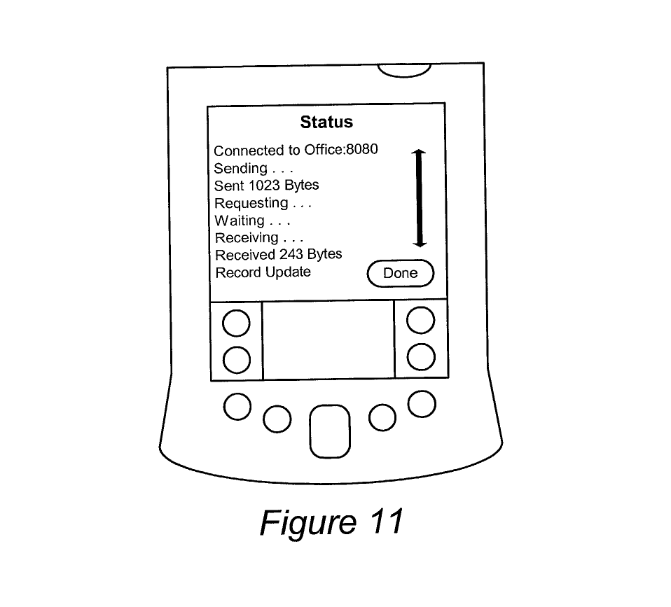

In some embodiments of the invention, the computer program displays the status of the transmission of data to and from the server on a “Status” screen. An example of a status screen is shown in FIG. 11.

5.7 Other Embodiments of the Invention

In some embodiments of the invention, only expense reports that have temporary expense report IDs are transmitted to the server. However in other embodiments of the invention, all expense reports stored in the computer are transmitted to the server even if the expense report has a final expense report ID.

In some embodiments of the invention, the server only transmits final expense report IDs to the computer. However in other embodiments of the invention, the server transmits expense report data and expense item data that had previously been transmitted to the server, retrieved from the server and then revised. For example, if the supervisor of a user disallows an expense item that had been previously transmitted to the server, then a revised expense report may be transmitted to the computer via a wireless network.

In some embodiments of the invention, the server is integrated with a company's financial system. In such embodiments, the company is able to accurately track expenses in real-time because the company does not have to wait until the business traveler returns from her trip to be aware of the expenses that the business traveler has incurred.

In some embodiments of the invention transmissions to and from the server are not encrypted. However in other embodiments of the invention, transmissions to and from the server are encrypted using encryption methods that are known in the art, such as the SSL transport mechanism.

5.8 Benefits of Embodiments of the Invention

Embodiments of the invention may be beneficial to any company that desires to maintain accurate expense reports. By allowing its employees the ability to record expenses in real-time, the accuracy of the employee's expense reports will be increased.

Embodiments of the invention may be particularly beneficial to business travelers that travel on lengthy trips. If a business traveler waited until she returned from such a trip to submit an expense report to her employer, her company may have already been required to pay the expenses incurred by the business traveler before it received the business traveler's expense report. Thus, the company could not determine whether the expense items were justified business expenses before the company paid the expenses. Embodiments of this invention provide the company with the ability to timely receive expense reports even if the business traveler is still traveling. Thus, the company can determine if expenses are justified before the company pays the expenses.

5.9 Conclusion

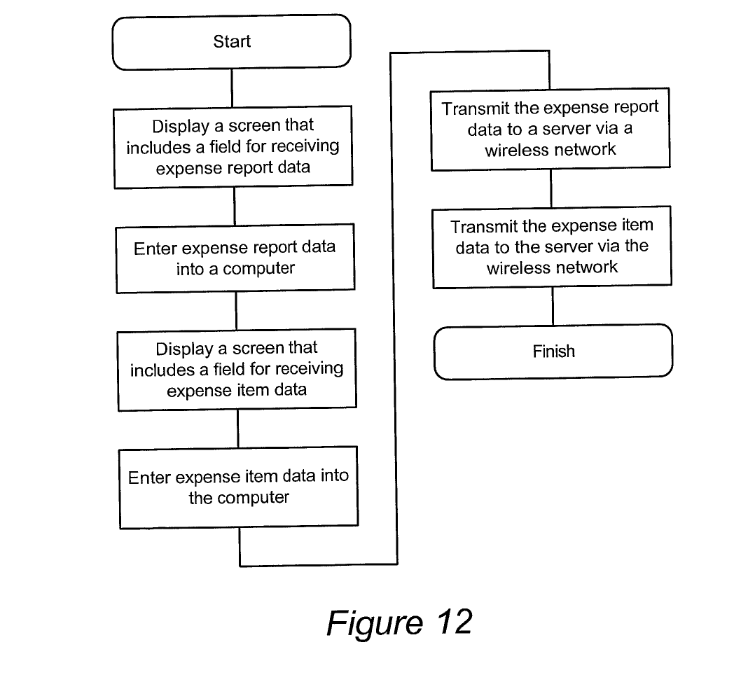

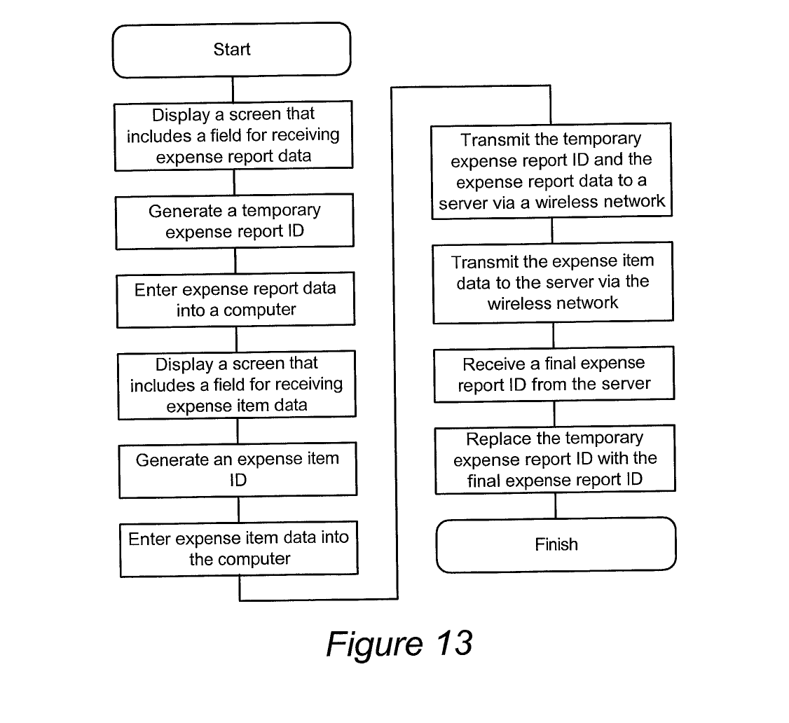

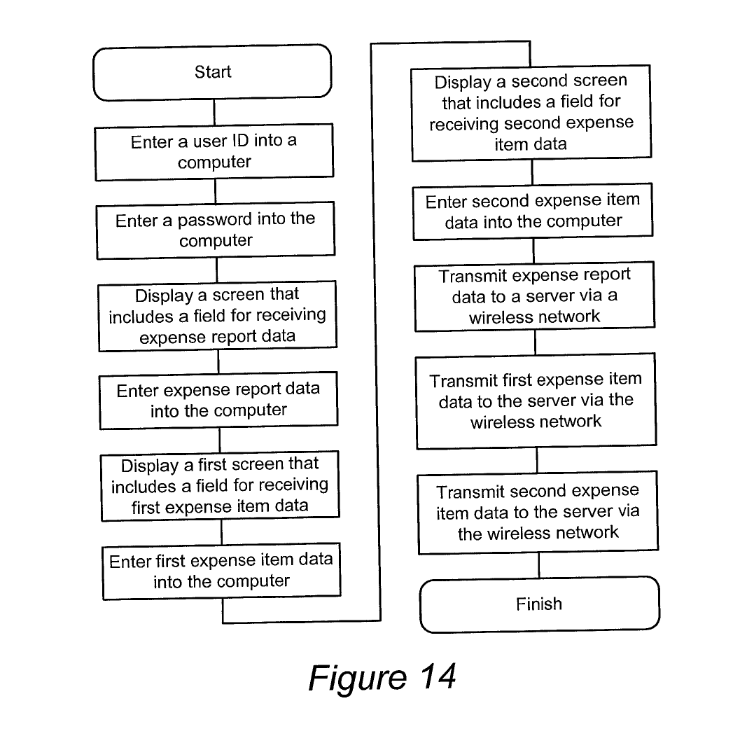

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. For example, one embodiment of the invention is shown in FIG. 12. Another embodiment of the invention is shown in FIG. 13. Still other embodiments of the invention would include program storage devices containing instructions that when executed by a computer, perform the methods discussed above. Examples of such program storage devices include random access memory, read only memory, hard disk drives, CDs, DVDs, floppy disks, and similar devices. Additionally, the above disclosure is not intended to limit the present invention. The scope of the present invention is defined by the appended claims.

It is claimed:

1. A method of transmitting expense report data and expense item data from a computer to a server comprising:
a) displaying a screen on the computer that includes a field for receiving expense report data;
b) entering expense report data into the computer;
c) displaying a screen on the computer that includes a field for receiving expense item data;
d) entering expense item data into the computer;
e) transmitting the expense report data from the computer to the server via a wireless network; and
f) transmitting the expense item data from the computer to the server via the wireless network.

2. The method of claim 1, wherein the act of displaying a screen on the computer that includes a field for receiving expense report data includes generating a temporary expense report ID and the act of displaying a screen that includes a field for receiving expense report data includes generating an expense item ID.

3. The method of claim 1, wherein the act of entering expense report data into the computer includes entering a date.

4. The method of claim 1, wherein the act of entering expense report data into the computer includes entering a plurality of dates.

5. The method of claim 1, wherein the act of entering expense report data into the computer includes entering a plurality of dates and a title of an expense event.

6. The method of claim 1, wherein the act of entering expense item data into the computer includes entering the type of the expense item.

7. The method of claim 1, wherein the act of entering expense item data into the computer includes selecting an expense item type from a plurality of expense item types.

8. The method of claim 1, wherein the act of entering expense item data into the computer includes entering a monetary amount.

9. The method of claim 1, wherein the act of transmitting the expense report data from the computer to the server includes transmitting the expense report via a Palm network.

10. The method of claim 1, wherein the act of transmitting the expense report data from the computer to the server includes transmitting the expense report via a cellular phone network.

11. The method of claim 1 further comprising:
g) entering a user ID into the computer; and
h) entering a password into the computer.

12. The method of claim 2 further comprising:
g) storing the temporary expense report ID and the expense report data in a first file on the computer; and
h) storing the temporary expense report ID, the expense item ID and the expense item data in a second file on the computer.

13. The method of claim 2 further comprising:
g) receiving a final expense report ID from the server; and
h) replacing the temporary expense report ID in the computer with the final expense report ID.

14. The method of claim 13 further comprising:
i) storing the final expense report ID in a first file on the computer; and
j) storing the final expense report ID and the expense item ID in a second file on the computer.

15. A method of transmitting expense report data and expense item data from a computer to a server comprising:
a) entering a user ID into the computer;
b) entering a password into the computer;
c) displaying a screen on the computer that includes a field for receiving expense report data;
d) entering expense report data into the computer;
e) displaying a first screen on the computer that includes a field for receiving first expense item data;
f) entering first expense item data into the computer;
g) displaying a second screen on the computer that includes a field for receiving second expense item data;
h) entering second expense item data into the computer;
i) transmitting the expense report data from the computer to the server via a wireless network;
j) transmitting the first expense item data from the computer to the server via the wireless network; and
k) transmitting the first expense item data from the computer to the server via the wireless network.

16. A program storage device containing instructions that when executed by a computer perform the following acts:
a) displaying a first screen on the computer, the first screen containing a field for receiving a user ID and a field for receiving a password;
b) displaying a second screen on the computer, the second screen containing a field for receiving expense report data;
c) displaying a third screen on the computer, the third screen containing a field for receiving expense item data; and
d) displaying a fourth screen on the computer, the fourth screen indicating the status of a wireless data transfer from the computer to a server.

17. The program storage device of claim 16 further containing instructions that when executed by the computer perform the following acts:
e) displaying a fifth screen on the computer, the fifth screen containing a temporary expense report ID.

18. The program storage device of claim 16 further containing instructions that when executed by the computer perform the following acts:
e) displaying a fifth screen on the computer, the fifth screen containing a final expense report ID.

19. The program storage device of claim 16 further containing instructions that when executed by the computer perform the following acts:
e) displaying a fifth screen on the computer, the fifth screen containing a temporary expense report ID and a final expense report ID.

20. The program storage device of claim 16 further containing instructions that when executed by the computer perform the following acts:
e) displaying a fifth screen on the computer, the fifth screen containing a final expense item ID that was transmitted from a server to the computer.
